(19) United States
(12) Patent Application Publication
(10) Pub. No.: US 2025/0318596 A1
(43) Pub. Date: Oct. 16, 2025

(54) Head-Mounted Devices with Comfort Bands

(71) Applicant: Apple Inc., Cupertino, CA (US)

(72) Inventors: Paul X Wang, Cupertino, CA (US); Yuhao Pan, Sunnyvale, CA (US); Venkata Narayana Murthy Arelekatti, Mountain View, CA (US); Jeremy C Franklin, San Francisco, CA (US); Nathaniel M Henderson-Cox, Seattle, WA (US); Jae Hwang Lee, Los Gatos, CA (US); Adam Y Kollgaard, Bainbridge Island, WA (US); Andrew Gallaher, Issaquah, WA (US); Antony John Edathattil, Sunnyvale, CA (US); Chad J Miller, Louisville, CO (US); Jackson C Masters, Newark, CA (US); John S Camp, Los Gatos, CA (US); Katherine E Christensen, Shoreline, WA (US); Ryan M David, San Francisco, CA (US); Zachary M Hammond, Mountain View, CA (US); Benjamin A Stevenson, Oakland, CA (US); Bryan A Cloyd, San Francisco, CA (US); Evan A Cernokus, Campbell, CA (US); Camille I Henrot, San Francisco, CA (US); Linda D Benavente-Notaro, Menlo Park, CA (US); Megan Grant, San Francisco, CA (US)

(21) Appl. No.: 19/084,008

(22) Filed: Mar. 19, 2025

Related U.S. Application Data
(60) Provisional application No. 63/632,766, filed on Apr. 11, 2024.

(51) Int. Cl. A42B 1/24; G06F 1/16

(52) U.S. Cl. CPC A42B 1/24; G06F 1/163

(57) ABSTRACT

A head-mounted device may include optical assemblies for presenting images to a user. The optical assemblies may be mounted in a head-mounted device housing. The head-mounted device housing may be supported at the front of the head of a user in front of the user's eyes using a headband system that includes one or more headbands and/or straps. The headband system may include a rear headband and an overhead strap, for example. A counterweight may be provided at the rear of the user's head to counterbalance the head-mounted device. The counterweight may be coupled to an extension of the head-mounted housing, and/or may be coupled to one of the headband(s) and/or strap(s). Additionally or alternatively, a pad may be coupled to, or embedded in one or more of the headband(s) and/or strap(s). By adjusting the headbands/straps, the counterweight(s), and/or the pad(s), the comfort of the headband system may be enhanced.

This application claims the benefit of U.S. provisional patent application No. 63/632,766, filed Apr. 11, 2024, which is hereby incorporated by reference herein in its entirety.

### FIELD

This relates generally to electronic devices, and, more particularly, to electronic devices such as head-mounted devices.

### BACKGROUND

Electronic devices have components such as displays and lenses. Headbands and/or straps may be used to help hold electronic devices such as head-mounted devices on the heads of users.

### SUMMARY

A head-mounted device may include optical assemblies for presenting images to a user. Each optical assembly may have a display and a lens. The optical assemblies may be mounted in a head-mounted device housing. Additional components such as sensors, input-output devices, fans, optical assembly positioning systems, and other components may be mounted in the housing.

The head-mounted device may be worn on the user's head using a headband system. The headband system may include one or more headbands and/or straps. The headband system may include a rear headband and an overhead strap, for example. The angle(s) of the straps may be adjusted to enhance the user's comfort while wearing the head-mounted device.

The weight of the housing tends to pull downwardly at the front of the user's head. A counterweight may be provided at the rear of the user's head to counterbalance the head-mounted device. The counterweight may be coupled to an extension of the head-mounted housing, and/or may be coupled to one of the headband(s) and/or strap(s).

Additionally or alternatively, a pad may be coupled to, or embedded in one or more of the headband(s) and/or strap(s). By adjusting the headbands/straps, the counterweight(s), and/or the pad(s), the comfort of the headband system may be enhanced.

### BRIEF DESCRIPTION OF THE DRAWINGS

FIG. 1 is a side view of an illustrative head-mounted device coupled to a head of a user with a headband system in accordance with some embodiments.

FIG. 2 is a side view of a headband system including an overhead strap, a rear headband, an optional upper headband, and an optional counterweight in accordance with some embodiments.

FIG. 3 is a side view of a headband system including an overhead strap, a lower rear headband, an optional upper headband, and an optional counterweight in accordance with some embodiments.

FIG. 4 is a top view of an illustrative head-mounted device with multiple attachment points for an overhead strap in accordance with some embodiments.

FIG. 5 is a side view of an illustrative headband system including an upper headband and a lower rear headband at angles relative to a head-mounted device in accordance with some embodiments.

FIG. 6 is a side view of an illustrative headband system including multiple headbands angled toward the rear of a user's head in accordance with some embodiments.

FIG. 7 is a side view of an illustrative headband system including an upper rear headband that extends from the back of the user's head to the front of the user's head in accordance with some embodiments.

FIG. 8 is a side view of an illustrative headband system including multiple headbands coupled to a head-mounted device at a torsion spring in accordance with some embodiments.

FIG. 9A is a side view of an illustrative headband system including multiple headbands coupled to a head-mounted device extension, a pad coupled to one of the headbands, and a counterweight coupled to the extension in accordance with some embodiments.

FIG. 9B is a front view of an illustrative counterweight support coupled to the head-mounted device extension in accordance with some embodiments.

FIG. 10 is a side view of an illustrative headband system including an upper headband with pads and a lower headband with counterweights in accordance with some embodiments.

FIG. 11A is a side view of an illustrative headband system with an overhead strap and a counterweight in accordance with some embodiments.

FIG. 11B is a perspective view of an illustrative headband system with a counterweight that attaches to a head-mounted device when stowed in accordance with some embodiments.

FIG. 12 is a side view of an illustrative headband system with a front upper headband coupled to a head-mounted device extension and to an additional portion of a head-mounted device in accordance with some embodiments.

FIG. 13 is a side view of an illustrative headband system with an upper headband and a rear headband that can modify centers of pressure applied to a user's head by a head-mounted device in accordance with some embodiments.

FIG. 14 is a side view of an illustrative headband system including a counterweight that is attached to a rear of the system and configured to rest on a front portion of a user when worn in accordance with some embodiments.

FIG. 15 is a side view of an illustrative headband system including a tensioner coupled to a rear headband to counteract the weight of a head-mounted device in accordance with some embodiments.

FIGS. 16A and 16B are front views of an illustrative headband formed from links coupled with ball and socket joints in accordance with some embodiments.

FIG. 17 is a perspective view of an illustrative headband with a comb in accordance with some embodiments.

### DETAILED DESCRIPTION

Head-mounted devices may have housings that are supported on a user's head using support structures such as headbands (e.g., a headband system). A head-mounted device may have a housing that rests against the front of a user's head in alignment with the user's eyes during use. This allows displays in the housing to present images to the user. The weight of the displays and other components in the housing tends to pull downward on the front of a user's head (e.g., on the user's face).

To adjust the force that the head-mounted device applies to the user's head, the headbands may be adjusted. For example, multiple headbands and/or straps may be provided at different angles and/or may contact the user's head at different locations to adjust a location of the pressure point(s) on the head. Alternatively or additionally, pads and/or counterweights may be provided adjacent to, on, or in one or more of the headbands to spread the load of the force and/or counterbalance the force. In this way, the force may be adjusted on the user's head to help enhance comfort.

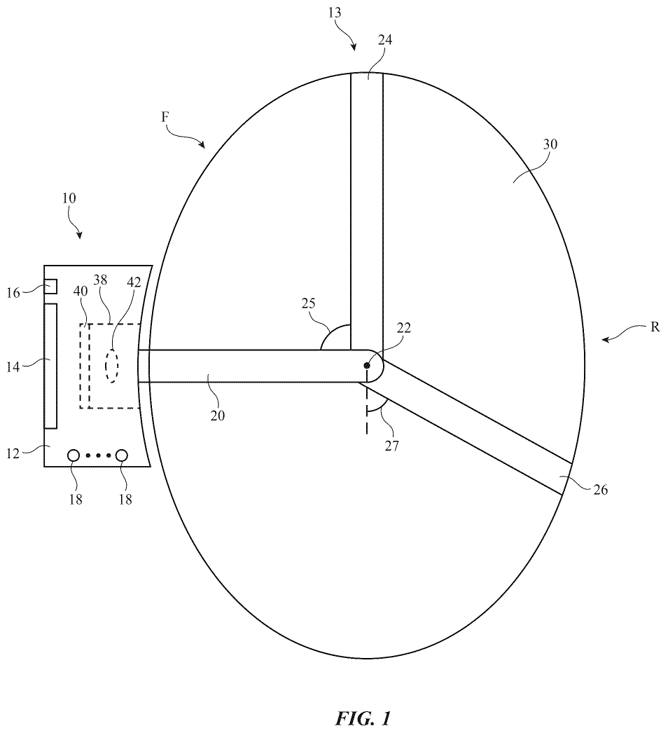

A side view of an illustrative head-mounted device with a headband system is shown in FIG. 1. As shown in FIG. 1, head-mounted device 10 (also referred to as device 10 herein) may have a housing such as housing 12 (also referred to as head-mounted housing 12 herein). Housing 12 may be worn on front F of a user's head such as head 30. Headband system 13 may be used to help hold housing 12 in place on head 30. In the illustrative example of FIG. 1, headband system 13 includes upper headband 24 (also referred to as top headband herein) and rear headband 26 at rear R of head 30. In general, however, headband system 13 may have one or more headbands and/or straps that hold housing 12 in place on head 30. Headbands 24 and 26 may be formed from straps, such as adjustable straps, that maintain sufficient friction/tightness on head 30 to hold housing 12 in place on head 30.

Housing 12 may contain a forward-facing display such as display 14 (e.g., a three-dimensional display having lenticular lenses overlapping an array of display pixels, or a two-dimensional display), sensors such as forward facing cameras 16, and other components 18 (e.g., control circuitry such as microprocessor circuitry, storage, application-specific integrated circuits, sensors, speakers, an optional battery, etc.). Left and right optical assemblies 38 (sometimes referred to as optical modules) may be used to display images in eye boxes. When a user's eyes are located in the eye boxes, left and right displays 40 and corresponding left and right lenses 42 in optical assemblies 38 may present images to the user (e.g., computer generated images, real-life images captured with cameras 16, and/or other content).

Head-mounted housing 12 may have stiff portions (e.g., a polymer shell, a glass cover layer over display 14, metal frame structures, and stiff structures formed from combinations of polymer, ceramic, glass, metal, and/or other stiff materials). These stiff portions may include elongated stiff housing extensions such as extension 20 (sometimes referred to as a power strap, elongated stiff housing portion, stiff strip-shaped extension, stiff extension, stiff strip, or stiff strap portion). In some embodiments, extension 20 and/or other stiff portions of head-mounted housing 12 may be rigid. Alternatively, one or more of extension 20 and/or other stiff portions of head-mounted housing 12 may exhibit a small amount of flexibility, or have flexible portions, while remaining stiff.

Extension 20 may be attached to and/or integrated with the body of housing 12 at front F of head 30 and may extend rearwardly past the ears of the user when device 10 is worn towards connection 22. In some embodiments, extension 20 may be fixedly attached to the body of housing 12 (e.g., extension 20 may not move and/or rotate relative to housing 12). However, this is merely illustrative. If desired, extension 20 may move (e.g., extend and retract) and/or rotate relative to housing 12 while being attached to housing 12.

Connection 22 may, if desired, have a first part that is fixedly attached to extension 20 and a second part that is carried on removable items such as headbands and/or counterweights. Headbands and counterweight structures may be attached to extension 20 at connection 22 and/or elsewhere along the length of extension 20. For example, connection 22 may include a post that engages with openings in one or more headbands of headband system 13. A latch may be used to attach the headbands to the post. However, this is merely illustrative. In general, connection 22 may include any suitable connector(s).

In the example of FIG. 1 device 10 has an upper headband such as headband 24. Headband 24 may have a narrow strip shape or a wider shape that extends over most or all of the top of head 30 from one side of head 30 to an opposing side of head 30. Headband 24 may be removably attached to extension 20 at connection 22. During use of device 10, headband 24 may help bear some of the weight of device 10 on the top of head 30. Headband 24 may be formed from a stretchy material (e.g., stretchable fabric and/or elastic materials) and/or may be partly or entirely formed from stiff materials (e.g., plastic, metal, and/or other stiff materials), such as at least partially rigid materials, stiffeners embedded in fabric, and/or other materials.

Device 10 may, if desired, have a rear headband such as headband 26. Headband 26, which may sometimes be referred to as a rear-of-head headband or rear headband, may be formed from a stretchy material (e.g., stretchable fabric and/or elastic materials) and/or may be partly or entirely formed from stiff materials (e.g., plastic, metal, and/or other stiff materials), such as at least partially rigid materials, stiffeners embedded in fabric, and/or other materials. During use of device 10, headband 26 may hug rear R of head 30 to help hold device 10 on head 30.

To adjust the pressure points applied to head 30 by device 10, headband 24 and/or headband 26 may be adjusted. For example, the position(s) of headband 24 and/or headband 26 may be adjusted to adjust the pressure points. As shown in the illustrative example of FIG. 1, headband 24 may extend at angle 25 from extension 20, and headband 26 may extend at angle 27 from a vertical axis that intersects connection 22. In the example of FIG. 1, angle 25 is 90° (or approximately 90°) and angle 27 is 45° (or approximately 45°). However, angles 25 and 27 may be adjusted to adjust the pressure points applied to head 30 when device 10 is worn. For example, angle 25 may be at least 10°, at least 20°, between 20° and 60°, between 10° and 80°, or greater than 90°, as examples. Angle 27 may be at least 30°, at least 40°, 90°, or another suitable angle. By adjusting angles 25 and 27, the pressure points of the force applied to head 30 by device 10 may be adjusted (e.g., moved and/or spread). In some embodiments, angles 25 and 27 may be different from each other.

Headband 24 and 26 may be attached to connection 22 at fixed angles (e.g., angles 25 and 27 may be fixed), or one or both of headbands 24 and 26 may be rotatably attached to connection 22 (e.g., angles 25 and 27 may be adjusted by a user).

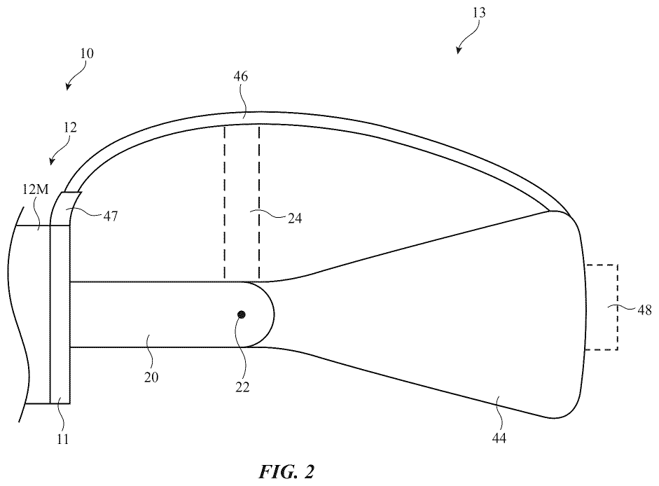

Instead of, or in addition to, adjusting an angle between headbands in headband system 13, an overhead strap and/or a counterweight may be used. An overhead strap may extend from device 10, over the user's head, and may be attached to a rear strap, a portion of the user, or other suitable anchor point. In other words, the overhead strap may extend over the top of the head from the front of the head to the rear of the head. A counterweight may be attached to the rear strap or may extend from extension 20. An illustrative example of a headband system that includes an overhead strap and/or a counterweight is shown in FIG. 2.

As shown in FIG. 2, headband system may include rear headband 44 attached to extension 20 at connection 22. Rear headband 44 may be connected to extension 20 using a magnet, a latch, a snap, or another suitable connection mechanism. In the example of FIG. 2, rear headband 44 has a large profile that will contact the rear of the user's head (rear R of FIG. 1). For example, rear headband 44 may be a knit band (a band knit out of fabric) or a band of another suitable material. The large profile at the rear of rear headband 44 may provide comfort for the user, as forces on the rear of the head may be spread out over a large area. However, the use of rear headband 44 with a large profile is merely illustrative. In some embodiments, rear headband 44 may have a single profile (e.g., similar to the profile of headband 26 of FIG. 1).

Overhead strap 46 may extend from device 10 to rear headband 44. Overhead strap 46 may be a flexible strap (e.g., a fabric strap or an elastomeric strap), a flexible strap with stiffeners on or in the strap, a stiff strap (e.g., a rigid or nearly-rigid strap, such as a strap formed from plastic or metal), or another suitable strap.

In the example of FIG. 2, housing 12 of device 10 has front portion 11 coupled to main housing portion 12M, and overhead strap 46 has a first end that is coupled to front portion 11 using connector 47. Front portion 11 may include a solid portion (e.g., a plastic or metal portion) of device 10 and may be referred to as a face track herein. Alternatively or additionally, front portion 11 may include a flexible portion (e.g., rubber, foam, and/or elastomer) and may be referred to as a light seal herein.

Connector 47 may be a clip, magnet, snap, or other suitable connector to attach overhead strap 46 to front portion 11. Alternatively or additionally, connector 47 may be an extension of the face track and/or light seal at front portion 11. However, the use of connector 47 is merely illustrative. In some embodiments, overhead strap 46 may be attached to front portion 11 directly. Alternatively or additionally, overhead strap 46 may be attached to main housing portion 12M.

Overhead strap 46 may be formed integrally with rear headband 44; or may have a second end that may be clipped onto rear headband 44, may be snapped onto rear headband 44, may be magnetically attached to rear headband 44 (e.g., using magnets on or in overhead strap 46 and rear headband 44), or may be otherwise attached to rear headband 44.

Optionally, upper headband 24 may be attached to extension 20 at connection 22. Headband 24 may extend over the top of the user's head from a first side of the head to an opposing side of the head (as shown in FIG. 1) and/or may be attached to overhead strap 46 (e.g., using clips, snaps, magnets, and/or other connectors).

In some embodiments, a counterweight may be used to counterbalance the weight of housing 12 at the front of the user's head. In the example of FIG. 2, optional counterweight 48 may be attached to rear headband 44. Counterweight 48 may be detachable (e.g., by a user) if desired. Alternatively, counterweight 48 may be fixedly attached to rear headband 44.

Counterweight 48 may include one or more weights that are provided in pocket(s) of rear headband 44, magnetically attached to rear headband 44 (e.g., magnetically attracted to magnets that are formed within rear headband 44), or otherwise attached to rear headband 44. Removably attached counterweight structures may be removed from headband system 13 by a user when a user is resting their head on a pillow, when a user is donning or doffing device 10, or when the counterweight is otherwise temporarily not desired.

Counterweight 48 may include one or more weights formed from polymer, metal (e.g., one or more heavy metals such as brass, tungsten, steel, etc.), and/or other materials. In some embodiments, counterweight 48 may be formed from one or more batteries (e.g., battery packs) that provide power to device 10 (e.g., through a cable that runs on or in headband system 13). The weight of counterweight 48 be at least 100 grams, at least 250 grams, between 250 grams and 400 grams, at least 500 grams, at least 1 kg, less than 1 kg, less than 750 grams, less than 300 grams, or less than 150 grams or any other suitable weight that allows counterweight 48 to provide a desired counterweight force. In this way, counterweight 48 may counterbalance the weight of device 10 and reduce the pressure applied to the front of a user's head (e.g., to the user's face).

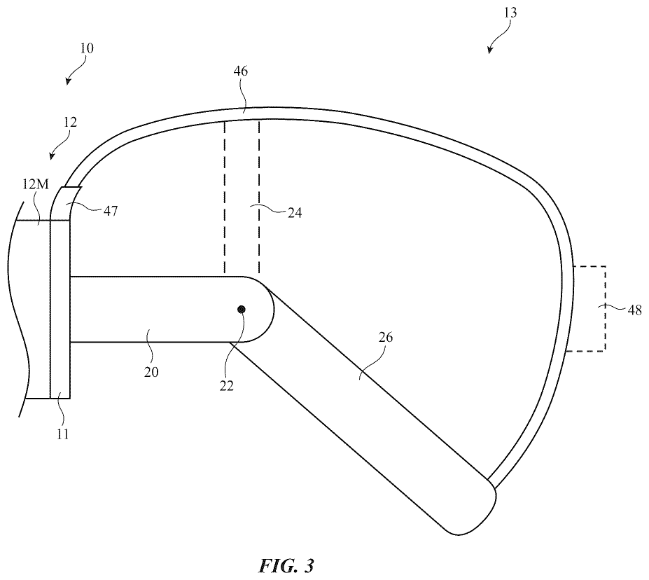

Although FIG. 2 shows rear headband 44 with a large profile, this is merely illustrative. If desired, other suitable headband(s) may be used in combination with an overhead strap and/or a counterweight. As shown in the illustrative example of FIG. 3, rear headband 26 may be attached to extension 20 and extend at an angle (as shown and described in connection with FIG. 1). Overhead strap 46 may have an end (e.g., an end opposite to the end attached to housing 12) attached to rear headband 26. For example, overhead strap 46 may be formed integrally with rear headband 26, may be clipped onto rear headband 26, may be snapped onto rear headband 26, may be magnetically attached to rear headband 26 (e.g., using magnets on or in overhead strap 46 and rear headband 26), or may be otherwise attached to rear headband 26. In general, headband system 13 may include any suitable headband(s) in addition to overhead strap 46.

However, the example in FIG. 3 in which overhead strap 46 is attached to rear headband 26 is merely illustrative. If desired, overhead strap 46 may terminate short of rear headband 26. In other words, there may be a gap between the end of overhead strap 46 and rear headband 26. Counterweight 48 may hold overhead strap 46 in tension on the user's head, and rear headband 26 may provide additional stability without being attached to overhead strap 46.

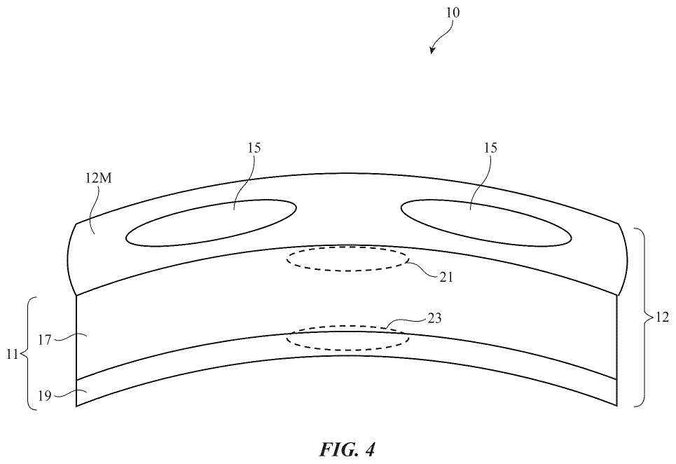

Regardless of the headband(s) included in headband system 13 in addition to overhead strap 46, overhead strap 46 may be attached to device 10 by clipping or otherwise attaching overhead strap 46 to main housing portion 12M or to front portion 11. Examples of illustrative locations in which overhead strap 46 (or another portion of headband system 13) may be attached to device 10 are shown in FIG. 4.

As shown in FIG. 4, device 10 may include vents 15 in main housing portion 12M. Vents 15 may be, for example, cooling vents, in which fans circulate air out of main housing portion 12M. Alternatively, vents 15 may be passive cooling vents that allow air to enter main housing portion 12M. Regardless of the type of vents in housing 12, vents 15 may be openings in main housing portion 12M, and overhead strap 46 (or another component of headband system 13) may be attached to main housing portion 12M by clipping or otherwise attaching to vents 15. For example, in an illustrative embodiment, overhead strap 46 may have a clip (e.g., connector 47 of FIGS. 2-3 may be a clip), and the clip may have a first portion that extends into one of vents 15 and a second portion that extends into the other one of vents 15 to hold overhead strap 46 in place relative to housing 12. However, this is merely illustrative. In general, one or more headbands and/or straps in headband system 13 may attach to housing 12 using any suitable connector.

Alternatively or additionally, device 10 may include front portion 11 with face track 17 and light seal 19. Face track 17 may be a stiff portion (e.g., a plastic or metal portion) of front portion 11, while light seal 19 may be a flexible portion (e.g., rubber, foam, and/or elastomer) that allows device 10 to conform to the user's face and block stray light from entering the user's eye boxes. However, this is merely illustrative. In general, face track 17 and light seal 19 may be shaped to conform to a user's face and may include any suitable materials.

Face track 17 may include opening 21, and light seal 19 may include opening 23. Overhead strap 46 (or another portion of headband system 13) may be attached to face track 17 in opening 21 and/or to light seal 19 in opening 23. For example, overhead strap 46 may have a clip or other connector (e.g., connector 47 of FIGS. 2-3) that may be removably coupled within opening 21 and/or opening 23. In this way, headband system 13 may be coupled to main housing portion 12M, face track 17, and/or light seal 19.

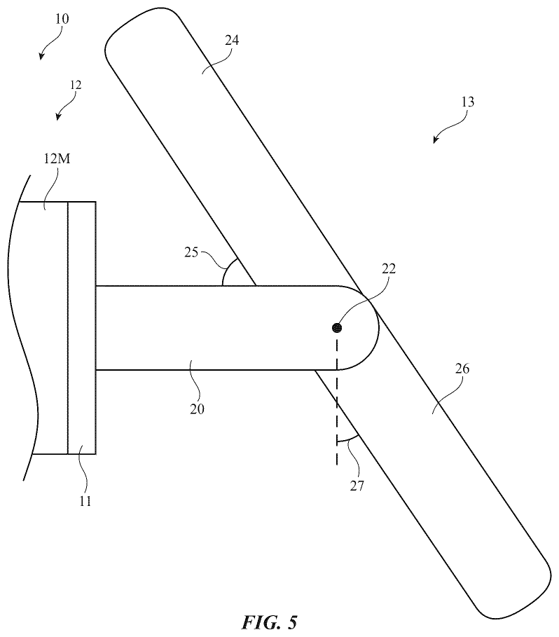

Instead of, or in addition to, incorporating overhead strap 46 into headband system 13, the angle(s) of headbands in headband system 13 may be adjusted to adjust the force and/or pressure points applied to a user's head/face by device 10. An illustrative example is shown in FIG. 5.

As shown in FIG. 5, headband system 13 may include headbands 24 and 26 attached to extension 20 at connection 22, similar to the arrangement shown in FIG. 1. However, in the illustrative embodiment of FIG. 5, headband 24 may be at angle 25 relative to extension 20, and angle 25 may be 45° or less, 35° or less, or another suitable angle. By providing headband 24 at an angle so that it contacts the front of a user's head (e.g., front F of head 30 in FIG. 1), the pressure from device 10 may be shifted from on the user's face to a point higher on the user's head, such as the user's forehead. This may provide enhanced comfort to the user.

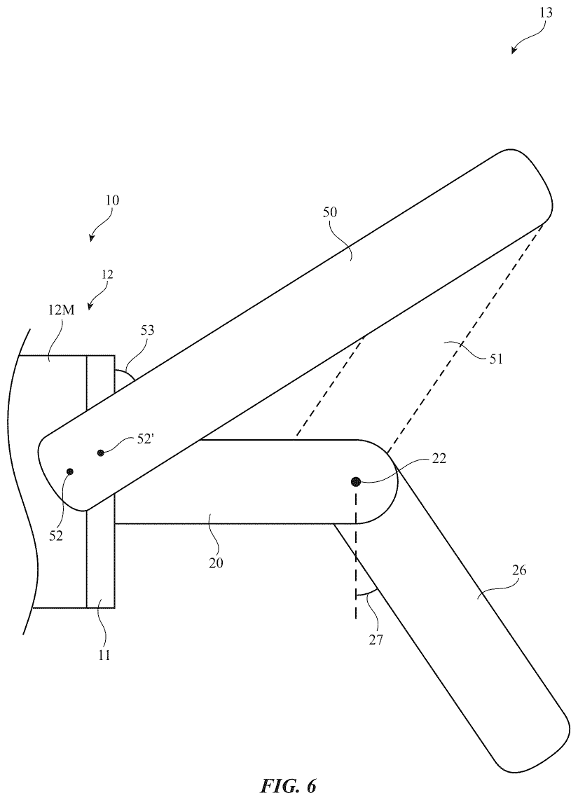

Instead of providing a headband that is angled toward the front of a user's head, headband system 13 may include multiple headbands angled toward the rear of the user's head. An illustrative example is shown in FIG. 6.

As shown in FIG. 6, headband system 13 may include rear headband 26 coupled to extension 20 at angle 27. Additionally, upper rear headband 50 may be coupled to main housing portion 12M of device 10 at connection 52 and/or may be coupled to front portion 11 at connection 52′. For example, upper rear headband 50 may be attached to connection 52 and/or connection 52′ using one or more clips, snaps, magnets, and/or other connectors.

Upper rear headband 50 may be formed from a stretchy material (e.g., stretchable fabric and/or elastic materials) and/or may be partly or entirely formed from stiff materials (e.g., plastic, metal, or other suitable materials), such as at least partially rigid materials, stiffeners embedded in fabric, and/or other materials. Upper rear headband 50 may extend from device 10 at angle 53, which may be at least 15°, at least 25°, between 10° and 45°, or another suitable angle. In general, headband 50 may contact the upper rear portion (rear R of FIG. 1) of a user's head. Due to upper rear headband 50 and lower rear headband 26, device 10 may exert less pressure on the user's face.

Optionally, headband system 13 may include additional headband 51 that is coupled to connection 22 and to upper rear headband 50. Additional headband 51 may be coupled to connection 52 using one or more clips, snaps, magnets, and/or other connectors. Additional headband 51 (which may be an upper rear headband) may be formed from a stretchy material (e.g., stretchable fabric and/or elastic materials) and/or may be partly or entirely formed from stiff materials (e.g., plastic, metal, or other materials), such as at least partially rigid materials, stiffeners embedded in fabric, and/or other materials. Providing additional headband 51 may provide more support to headband system 13 and therefore further reduce the pressure exerted by device 10 on the user's face when device 10 is worn.

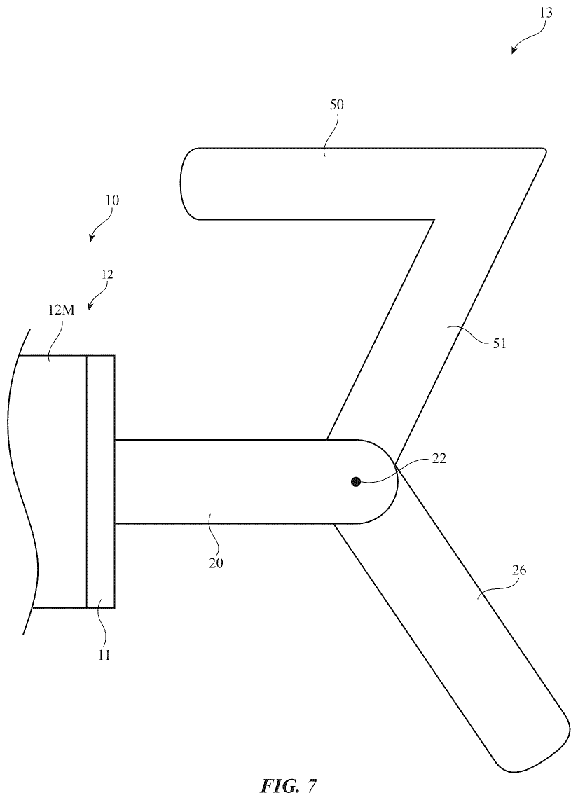

Although headband 50 is shown as being coupled to device 10 in FIG. 6, this is merely illustrative. In some embodiments, an upper rear headband may extend from the back of a user's head to the front of the user's head, such as to the user's forehead. An illustrative example is shown in FIG. 7.

As shown in FIG. 7, headband 50 may be coupled to additional headband 51, which in turn may be attached to connection 22 of extension 20. In particular, headband 50 may extend from additional headband 51, which may contact the rear of the user's head (e.g., rear R of FIG. 1), parallel (or nearly parallel) to the top of device 10/the ground beneath the user. In this way, headband 50 may contact the front of the user's head (e.g., front F of FIG. 1), such as the user's forehead. By including headband 50 to contact the user's forehead (or other upper portion of the user's head), the pressure exerted by device 10 on the user's face may be moved upwards, which may enhance user comfort.

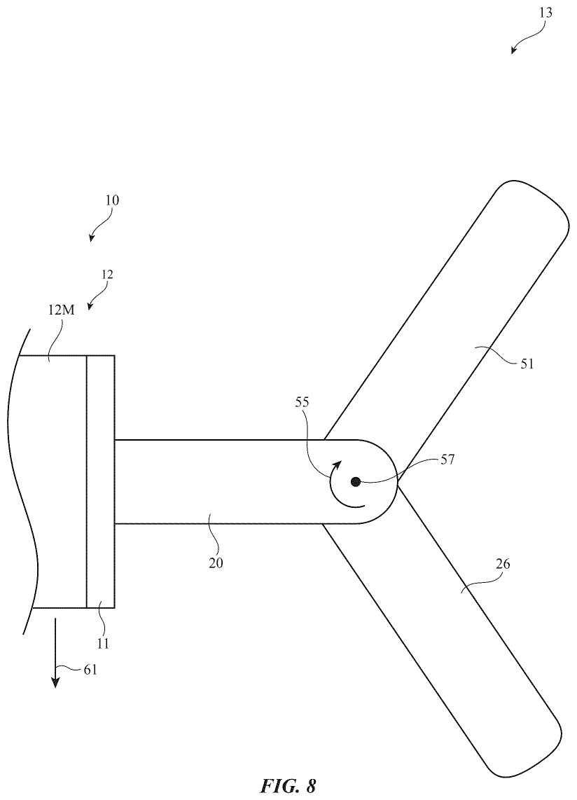

Instead of, or in addition to, providing front and/or upper rear straps, headbands in headband system 13 may be attached to extension 20 using a torsion spring. The torsion spring may provide an upward rotational force to counteract the downward force from device 10 on the user's face. An illustrative example is shown in FIG. 8.

As shown in FIG. 8, headbands 26 and 51, which may contact the lower rear and upper rear of the user's head, respectively, may be coupled to extension 20 using torsion spring 57. Torsion spring 57 may provide an upward rotational force in direction 55. This upward rotational force may counteract the downward force of device 10 in direction 61. Therefore, device 10 may apply less force/pressure on the user's face, which may enhance the comfort of the user while wearing device 10.

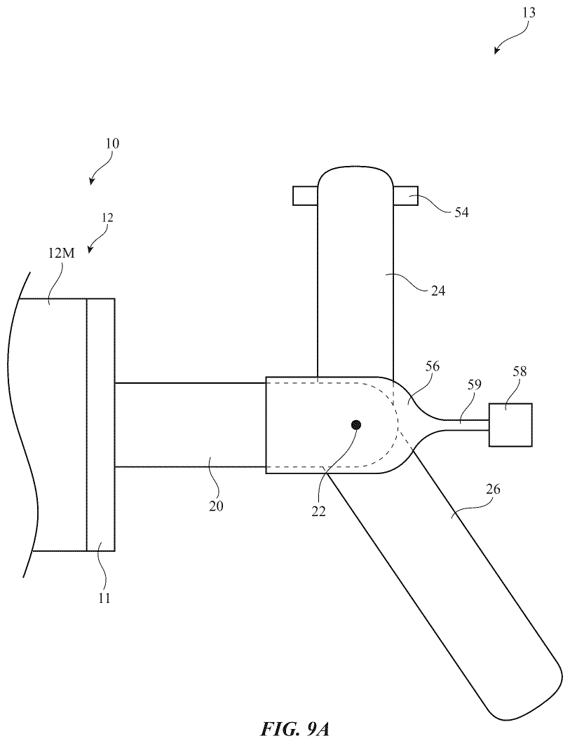

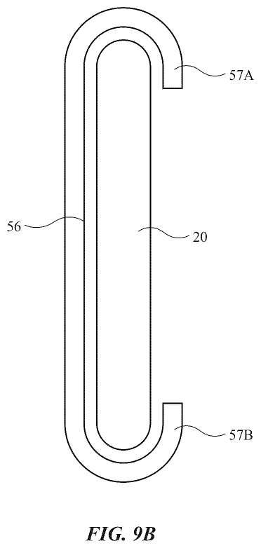

Regardless of the headbands/straps used in headband system 13, one or more pads and/or counterweights may be provided to further enhance user comfort. An illustrative example is shown in FIG. 9A.

As shown in FIG. 9A, headband system 13 may include pad 54 attached to headband 24. Pad 54 may be formed from foam material, elastomeric material, hydrostatic material (e.g., a non-Newtonian fluid), a heat moldable material that can conform to the user's head shape (e.g., a heat moldable material with a molding temperature near the user's body heat so that the material conforms to the user's head while being worn, or a head moldable material with a higher molding temperature so that the material maintains its shape while being worn), or other suitable material. Pad 54 may be formed from flexible material and/or stiff material. In some embodiments, pad 54 may be rotatably coupled to headband 24 (e.g., so that pad 54 may maintain contact with the user's head when headband 24 moves). In general, pad 54 may spread the pressure applied to the top of the user's head across a greater surface area and/or may cushion the contact region on the top of the user's head. In this way, pad 54 may improve the user's comfort while device 10 is being worn.

Alternatively or additionally, counterweight 58 may be provided in headband system 13. In the illustrative example of FIG. 9A, counterweight 58 is attached to support 56, which in turn is attached to extension 20. For example, support 56 may be a plastic support member, a metal support member, or a support member of other suitable material to which counterweight 58 is attached.

Counterweight 58 may include one or more weights formed from polymer, metal (e.g., one or more heavy metals such as brass, tungsten, steel, etc.), and/or other materials. In some embodiments, counterweight 58 may be formed from one or more batteries (e.g., battery packs) that provide power to device 10 (e.g., through a cable that runs on or in headband system 13). The weight of counterweight 58 be at least 100 grams, at least 250 grams, between 250 grams and 400 grams, at least 500 grams, at least 1 kg, less than 1 kg, less than 750 grams, less than 300 grams, or less than 150 grams or any other suitable weight that allows counterweight 58 to provide a desired counterweight force. In this way, counterweight 58 may counterbalance the weight of device 10 and reduce the pressure applied to the front of a user's head (e.g., to the user's face).

Counterweight 58 may be fixedly attached to arm 59 of support 56, or counterweight 58 may be slidable relative to arm 59. In embodiments in which counterweight 58 is slidable relative to/along arm 59, a user may slide counterweight 58 to adjust the distance between counterweight 58 and extension 20. This adjusts how much counterbalancing torque is produced. When counterweight 58 is moved closer to extension 20, the lever arm of counterweight 58 is shortened and the counterweight effect is decreased. When counterweight 58 is moved farther from extension 20, the lever arm of counterweight 58 is increased and the counterweight effect is increased. In this way, the user may make adjustments to ensure that the forward-rear balance of device 10 is comfortable for the user.

As shown in the illustrative example of FIG. 9B, support 56 may have upper and lower clips 57A and 57B, respectively, that clip onto extension 20. In this way, support 56 (and therefore counterweight 58) may be attached to and removed from extension 20 as desired by a user of device 10.

Although FIG. 9B shows support 56 attaching to extension 20 using clips 57A and 57B, this is merely illustrative. In some embodiments, support 56 may entirely surround extension 20 (e.g., support 56 may slide onto extension 20, such as before headbands 24 and 26 are attached to extension 20). Alternatively, support 56 may attach to connection 22 or otherwise attach to extension 20, such as through one or more snaps, latches, magnets, or other connectors. In this way, support 56 may be removably attached to extension 20.

Additionally, although FIG. 9A shows the use of upper headband 24 and rear headband 26 with counterweight 58, this is merely illustrative. In some embodiments, headband 51 (FIG. 8), headband 50 (FIGS. 6 and 7), overhead strap 46 (FIGS. 2 and 3), and/or rear headband 44 (FIG. 2) may be used with counterweight 58. In an illustrative embodiment, for example, headband system 13 may include upper headband 24, rear headband 44, and counterweight 58 attached to extension 20.

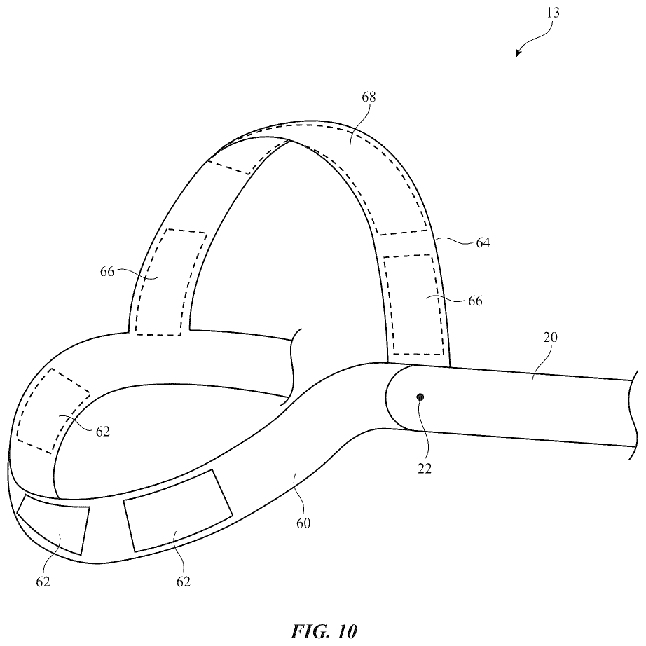

In the example of FIG. 9A, pad 54 and counterweight 58 are formed outside of headbands 24 and 26 of headband system 13. In some embodiments, however, one or more pads and/or one or more counterweights may be incorporated into/onto one or more headbands of headband system 13. An illustrative example is shown in FIG. 10.

As shown in FIG. 10, headband system 13 may include upper headband 64 and lower headband 60 (also referred to as rear headband 60 and lower rear headband 60 herein) attached to extension 20. Upper headband 64 and lower rear headband 60 may be formed from a stretchy material (e.g., stretchable fabric and/or elastic materials) and/or may be partly or entirely formed from stiff materials (e.g., plastic, metal, or other material), such as at least partially rigid materials, stiffeners embedded in fabric, and/or other materials. Although upper headband 64 is shown as extending vertically (e.g., to contact the top of the user's head) and rear headband 60 is shown as extending backwards and downwardly (e.g., to contact the lower rear of the user's head), this is merely illustrative. In general, headbands 64 and 60 may extend in any suitable directions relative to extension 20. Additionally or alternatively, additional headbands and/or straps may be included in headband system 13.

Lower headband 60 may include counterweights 62 on a surface of rear headband 60 (e.g., on an outer surface or an inner surface) or embedded within rear headband 60 (e.g., between the outer surface and the inner surface). Counterweights 62 may be rods or other weights that can optionally be inserted and removed into lower headband 60, spheres or other small weighted particles within headband 60 (or in another material, such as silicone) and attached to or embedded within headband 60), material that is magnetically attached to headband 60, or other suitable weights. In some illustrative embodiments, tungsten, steel, or brass spheres (or particles of other shapes) may be embedded within headband 60 (or silicone and attached to headband 60) to form counterweights 62. For example, the spheres (or other particles) may have a density of at least 50%, of at least 60%, of 64%, of between 30% and 75%, or other suitable density to provide counterweight while conforming to a user's head. In this way, counterweights 62 may counteract the force of a device attached to headband system 13, while conforming to the user's head.

Upper headband 64 may include pads 66 and/or 68 embedded in upper headband 64 or attached to a surface of upper headband 64. Pads 66 and/or 68 may be formed from foam, elastomer, polymer, and/or other suitable materials. In general, pads 66 and/or 68 may spread the pressure applied to the user's head across a greater surface area and/or may cushion the contact region on the user's head. In this way, pads 66 and/or 68 may improve the user's comfort while a device attached to headband system 13 is being worn.

Although FIG. 10 shows pads 66 and 68 on upper headband 64, and counterweights 62 on lower headband 60, this is merely illustrative. In general, pads, such as pads 66 and/or 68, may be incorporated into any suitable portion of headband system 13, such as in lower headband 60. Similarly, counterweights 62 may be incorporated into any suitable portion of headband system 13, such as an upper rear headband.

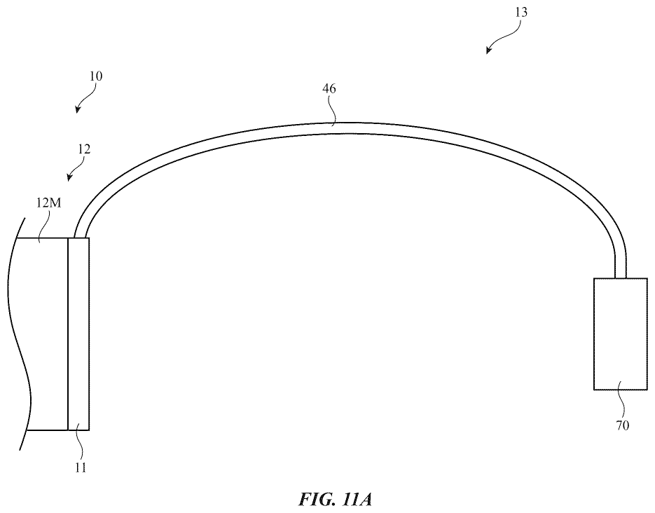

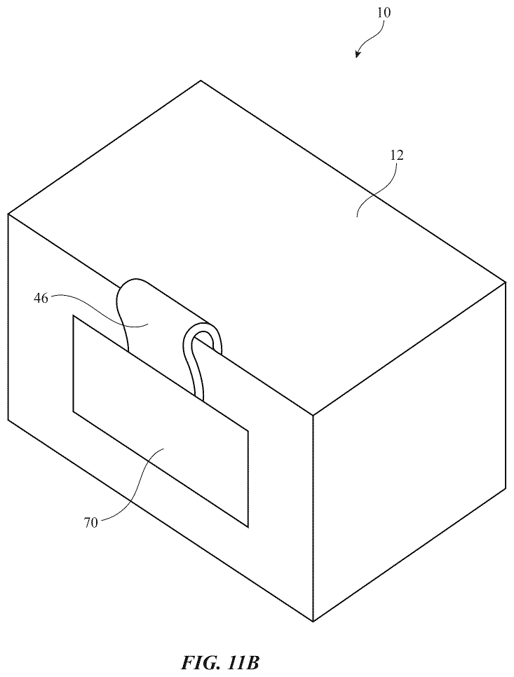

In some embodiments the use of a counterweight may allow headband system 13 to be simplified. In other words, a counterweight may balance a head-mounted device attached to headband system 13 on the user's head, and the number of headbands/straps used in headband system 13 may be reduced. An illustrative example is shown in FIG. 11A.

As shown in FIG. 11A, headband system 13 may include overhead strap 46 and counterweight 70. Counterweight 70 may be a battery, one or more metal weights (or weights of other suitable material), or any other suitable counterweights. Overhead strap 46 may be formed from fabric (e.g., fabric with one or more stiffeners, or fabric without stiffeners), plastic, elastomer, metal, and/or other suitable material. Overhead strap 46 may have a first end coupled to device 10 and a second end coupled to counterweight 70.

Device 10 may weigh at least 400 grams, at least 500 grams, between 550 grams and 700 grams, at least 600 grams, less than 1 kg, or another amount. To offset the weight of device 10, counterweight 70 may weigh at least 100 grams, at least 250 grams, at least 500 grams, at least 1 kg, less than 1 kg, less than 750 grams, less than 300 grams, or less than 150 grams or any other suitable weight that allows counterweight 70 to provide a desired counterweight force. For example, the friction of overhead strap 46 on the user's head may allow counterweight 70 have a lower weight than device 10. However, this is merely illustrative. Counterweight 70 may the same as, or more than, device 10, if desired.

Due to overhead strap 46 and counterweight 70, device 10 may be maintained against the user's face when worn. In other words, counterweight 70 may maintain overhead strap 46 in tension against the user's head. Therefore, additional headbands may be omitted from headband system 13, if desired. However, one or more additional headbands, such as a top headband, a front headband, and/or one or more rear headbands, may be incorporated into headband system 13 for additional stability (e.g., when a user of device 10 is actively moving, such as exercising).

When not in use, counterweight 70 may be stowed by attaching counterweight 70 to device 10. An illustrative example is shown in FIG. 11B.

As shown in FIG. 11B, counterweight 70 may be attached to housing 12 of device 10 when not in use. For example, counterweight 70 may be clipped to, snapped to, magnetically attached to, or otherwise attached to main housing portion 12M (FIG. 4) of device 10. Alternatively or additionally, counterweight 70 may be attached to front portion 11 of device 10 (see FIG. 4). By attaching counterweight 70 to device 10 when device 10 is not in use, components in device 10, such as lenses, displays, sensors, and/or other components, may be covered by counterweight 70 and therefore protected.

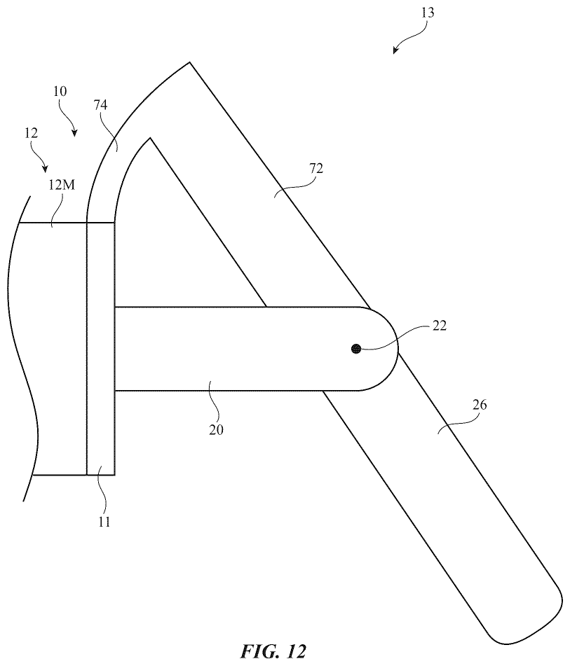

In some embodiments, it may be desirable to provide headbands at the upper front and lower rear of the user's head. An illustrative example of a headband system with an upper front headband and a lower rear headband is shown in FIG. 12.

As shown in FIG. 12, headband system 13 may include lower rear headband 26 and front upper headband 72 (also referred to as upper headband 72 herein) attached to extension 20 at connection 22, such as using one or more snaps, latches, magnets, or other connectors.

Upper headband 72 may be formed from a stretchy material (e.g., stretchable fabric and/or elastic materials) and/or may be partly or entirely formed from stiff materials, such as at least partially rigid materials (e.g., plastic, metal, or other materials), stiffeners embedded in fabric, and/or other materials. Upper headband 72 may contact the upper front portion of the user's head (e.g., the user's forehead or above the user's forehead).

Portion 74 may extend downwardly from the top of upper headband 72, along the user's head when headband system 13 is worn, and may be attached to front portion 11 (and/or main housing portion 12M) of device 10. Portion 74 may be formed integrally with a portion of device 10, or may be attached to device 10 using one or more snaps, latches, magnets, or other connectors. By including portion 74, headband system 13 may further rebalance the weight of device 10, improving user comfort.

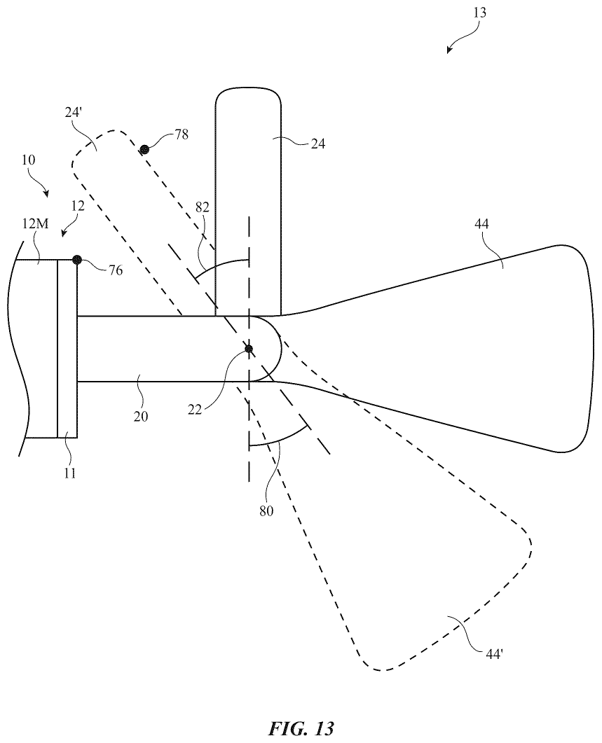

In general, regardless of the types of headbands/straps that are used in a headband system, the angle(s) of the headbands/straps may be set (or adjusted) to move the center of pressure on a user's head to a more comfortable position. An illustrative example is shown in FIG. 13.

As shown in FIG. 13, headband system 13 may include upper headband 24 and rear headband 44. In embodiments in which rear headband 44 is parallel to extension 20 and upper headband 24 is perpendicular to extension 20, device 10 may apply force to a user's head with center of pressure 76. However, center of pressure 76 may be on the user's face, so it may be desirable to move the center of pressure to a higher position on the user's head.

Therefore, rear headband 44 may be moved downwardly from parallel to extension 20 by angle 80, and upper headband 24 may be moved downwardly (toward the front of the user's head) by angle 82. Angle 80 may be at least 15°, at least 25°, at least 35°, between 10° and 50°, or 45°, as examples, between a vertical line (e.g., a line perpendicular to extension 20) through connection 22 and a center axis of rear headband 44. Angle 82 may be at least 15°, at least 25°, at least 35°, between 10° and 50°, at least 55°, or 45°, as examples, between a vertical line (e.g., a line perpendicular to extension 20) through connection 22 and a center axis of upper headband 24. By positioning rear headband 44 at angle 80 and upper headband 24 at angle 82, the center of pressure of device 10 on the user's head may be moved to center of pressure 78, which may be higher on the user's head (e.g., on the user's forehead or above the user's forehead). In this way, the center of pressure may be moved off of the user's face, which may enhance the user's comfort while device 10 is worn.

The positions of upper headband 24 and rear headband 44 may be adjustable relative to extension 20 (e.g., upper headband 24 and/or rear headband 44 may be rotated about connection 22) to adjust angles 80 and 82. Alternatively, the position of upper headband 24 and/or rear headband 44 may be fixed relative to extension 20.

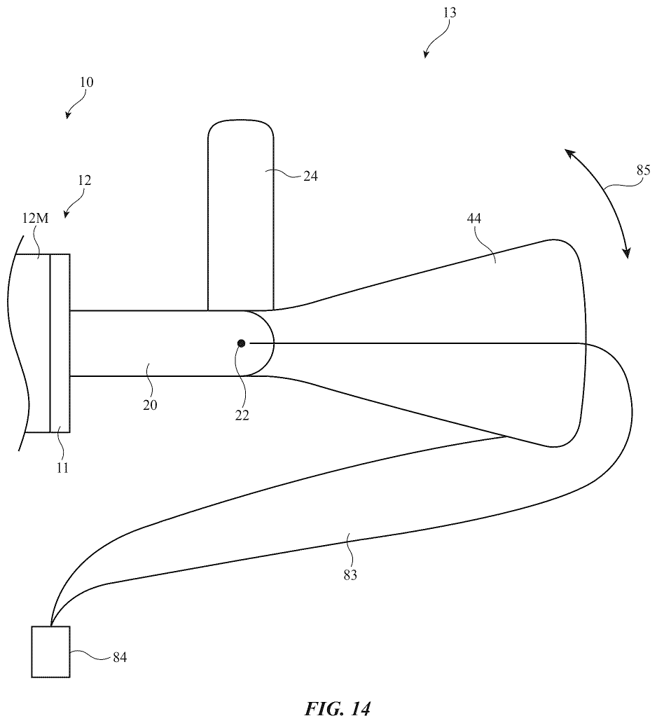

Counterweights that may be included in a headband system, such as counterweight 48 (FIGS. 2-3), counterweight 58 (FIG. 9A), counterweights 62 (FIG. 10), and counterweight 70 (FIGS. 11A-B) have been shown and described as being at the rear of headband system 13. However, this is merely illustrative. In some embodiments, it may be desirable to have a counterweight attached to the rear of headband system 13, but rest at the front of a user (e.g., by passing over the shoulders of the user). An illustrative example is shown in FIG. 14.

As shown in FIG. 14, headband system 13 may include counterweight 84 attached to extension 20 at connection 22 via hanger 83. Hanger 83 may be formed from fabric, polymer, metal, plastic, and/or other suitable material(s). Hanger 83 may attach to connection 22 via one or more snaps, latches, magnets, and/or other connectors.

Counterweight 84 may be a battery, one or more metal weights (or weights of other suitable material), or any other suitable counterweights. Counterweight 84 may weigh at least 100 grams, at least 250 grams, between 250 grams and 400 grams, at least 500 grams, at least 1 kg, less than 1 kg, less than 750 grams, less than 300 grams, or less than 150 grams or any other suitable weight that allows counterweight 84 to provide a desired counterweight force to counteract the weight of device 10.

Although counterweight 84 is attached to the rear of headband system 13, counterweight 84 may pass across the user's shoulders when headband system 13 is worn, resting against the front of the user (e.g., the user's chest). In this way, counterweight 84 may be more stable and provide a desired counterbalance force to counteract the weight of device 10.

Additionally, rear headband 44 (and/or upper headband 24) may be rotated in direction 85 to change the angle(s) between the headband(s) and extension 20 and adjust the center of pressure on the user's head. However, this is merely illustrative. Rear headband 44 and upper headband 24 may be attached to extension 20 in a fixed position, if desired.

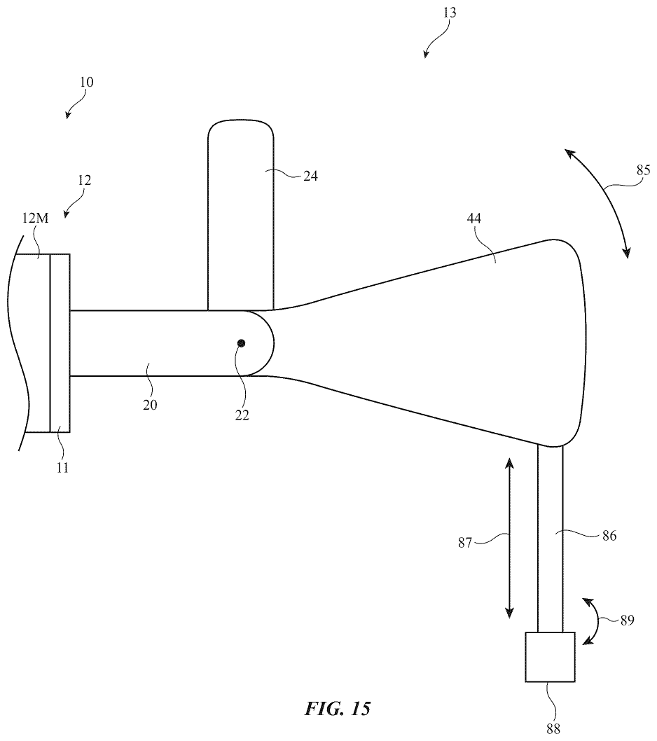

As an alternative to providing a counterweight, a tensioner may be attached to a rear portion of headband system 13 and to a portion of the user, such as the user's clothes. This may provide a counterbalancing force without a counterweight. An illustrative example is shown in FIG. 15.

As shown in FIG. 15, tensioner 86 may be attached to rear headband 44. Tensioner 86 may be formed from elastic, fabric, plastic, metal, polymer, and/or any other suitable material. Tensioner 86 may be formed integrally with rear headband 44 (e.g., tensioner 86 may be sewn or knit into rear headband 44) or a first end of tensioner 86 may be attached to rear headband 44 with one or more snaps, latches, hook and loop fasteners, magnets, and/or other connectors.

Clip 88 may be attached to an end of tensioner 86 opposing rear headband 44. Clip 88 may be a carabiner or other clip that may be attached to a portion of the user, such as the user's clothes, when headband system 13 is worn.

The length of tensioner 86 may be adjusted along directions 87 to adjust the tension applied to rear headband 44. For example, tensioner 86 may be a telescoping tensioner, a flexible tensioner, or a strap that may be lengthened and/or shortened (e.g., through a buckle), as examples. Additionally, tensioner 86 may move rotate relative to clip 88 in directions 89 and/or rear headband 44 may rotate relative to extension 20 in directions 85.

By adjusting the length of tensioner 86, the position of rear headband 44, and/or the position of tensioner 86 relative to clip 88, the tension applied to headband system 13 may be adjusted. In particular, a user may adjust tensioner 86 to counteract the force of device 10 and improve the comfort of device 10 when worn.

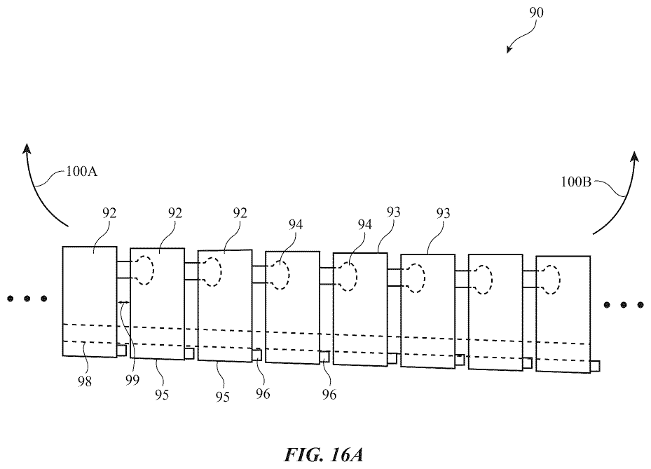

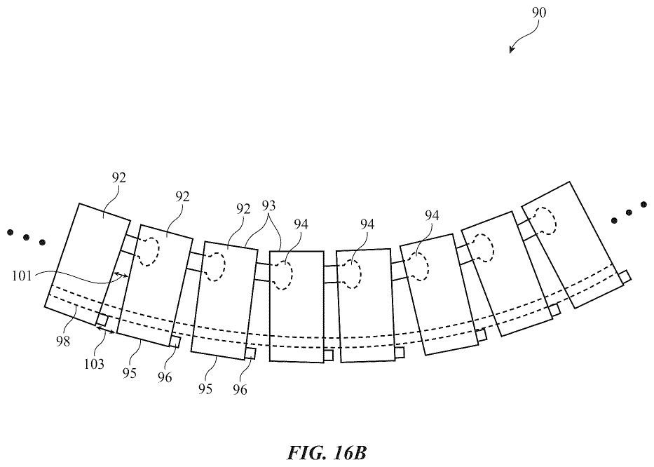

In the examples of FIGS. 1-15, headbands and overhead straps in headband system 13 have been described as being formed from a stretchy material (e.g., stretchable fabric and/or elastic materials) and/or may be partly or entirely formed from stiff materials, such as at least partially rigid materials, stiffeners embedded in fabric, and/or other materials. In some illustrative embodiments, the headbands and overhead straps may be formed from fabric with or without stiffeners on or in the fabric. Alternatively, the headbands and/or overhead straps may be formed from links that are interconnected with ball and socket joints to help the headbands/straps conform to the user's head while maintaining a desired curvature. An illustrative example is shown in FIGS. 16A and 16B.

As shown in FIG. 16A, headband 90 may include links 92. Each link 92 may be attached to a neighboring link 92 at ends 93 using ball and socket joint 94. At ends 95, each link 92 may have protrusions 96 that act as kinematic stops that can contact the neighboring link 92 and prevent the links from moving past a desired point. Alternatively or additionally to protrusions 96, band 98 may extend across ends 95 of links 92 to provide resistance to the separation of links 92. Band 98 may be formed from an elastic material, for example.

When headband 90 is at rest, links 92 may be separated by distance 99 at ends 93 and ends 95. Distance 99 may be at least 1 mm, at least 2 mm, between 2 mm and 5 mm, less than 15 mm, or other suitable distance. Due to ball and socket joints 94, links 92 may separate at ends 95 when the ends of headband 90 are moved in directions 100A and 100B. An illustrative example is shown in FIG. 16B.

As shown in FIG. 16B, when headband 90 has been moved in directions 100A and 100B, links 92 may be further apart at ends 95 than at ends 93. In particular, links 92 may be at least 5 mm, at least 10 mm, between 5 mm and 25 mm, or other suitable distance apart at ends 95 (as shown by distance 103) and may be at least 1 mm, at least 2 mm, between 2 mm and 5 mm, less than 15 mm, or other suitable distance apart at ends 93 (as shown by distance 101).

While headband 90 may be stretched, band 98 may limit the distance that links 92 can be separated at ends 95. In this way, when worn, headband 90 may conform to the curvature of the user's head up to a maximum curvature, which may be set by band 98.

Headband 90 may be used in any suitable position within a headband system. For example, headband 90 may be used as top headband 24 and/or rear headband 26 (FIG. 1), rear headband 44 and/or overhead strap 46 (FIG. 2), headbands 50 and/or 51 (FIGS. 6 and 7), headbands 60 and/or 64 (FIG. 10), headband 72 (FIG. 12), and/or any other suitable headbands/straps in headband system 13. A counterweight and/or a pad may be added to headband 90, if desired.

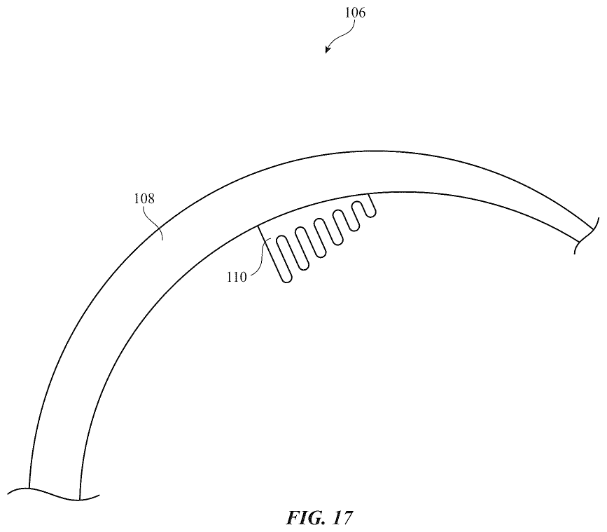

Instead of, or in addition to, including pads in or on a headband in a headband system (e.g., pad 54 of FIG. 9A and/or pads 66/68 of FIG. 10), a comb may be added to or incorporated into a headband to maintain the position of the headband on a user's head. An illustrative example is shown in FIG. 17.

As shown in FIG. 17, headband 106 may include headband portion 108 and comb 110. Headband portion 108 may be formed from a stretchy material (e.g., stretchable fabric and/or elastic materials) and/or may be partly or entirely formed from stiff materials, such as at least partially rigid materials, stiffeners embedded in fabric, and/or other materials. Comb 110 may be attached to headband portion 108, such as having a portion that is sewn/knitted into headband portion 108, having a portion that is adhesively attached to headband portion 108, and/or having a portion that is snapped, latched, magnetically attached, secured with a hook and loop fastener, or otherwise attached to headband portion 108.

Comb 110 may be formed from a stiff material, such as plastic, metal, or other suitable material. In some embodiments, comb 110 may be a rigid material. When headband 106 is worn by a user, comb 110 may provide additional friction for headband 106 (e.g., comb 110 may be pushed into the user's hair). In this way, headband 106 may maintain its position on the user's head, and headband 106 may provide additional support when worn.

Headband 106 may be used in any suitable position within a headband system. For example, headband 106 may be used as top headband 24 and/or rear headband 26 (FIG. 1), rear headband 44 and/or overhead strap 46 (FIG. 2), headbands 50 and/or 51 (FIGS. 6 and 7), headbands 60 and/or 64 (FIG. 10), headband 72 (FIG. 12), and/or any other suitable headbands/straps in headband system 13. A counterweight and/or a pad may be added to headband 106, if desired.

Although headbands in a headband system have been described as attaching to a connection point of an extension from a head-mounted device housing (e.g., connection 22 of extension 20 of FIGS. 1-3, 5-7, 9, 10, and 12-15), this is merely illustrative. In general, headbands in a headband system may be attached to any suitable portion of a head-mounted device, such as main housing portion 12M and/or front portion 11 of device 10 (FIGS. 1-4). Alternatively or additionally, headbands in a headband system may be attached to an add-on connection point to a head-mounted device. In other words, a connection point may be attached to a main housing portion and/or front portion of device 10, and the headbands may be attached to that connection point. Additionally or alternatively, multiple connection points may be provided on main housing portion 12M and/or front portion 11, and/or added onto main housing portion 12M and/or front portion 11, and a user of device 10 may select headbands and/or straps that can attach to one or more of the connection points, allowing for an adjustment of force applied to the user's head/face.

Regardless of the connection point of the headband(s), the headband system may include one or more headbands and/or straps at any suitable angle, as well as one or more pads, counterweights, tensioners, and/or combs. In this way, the force applied to a user's face/head may be counteracted, spread, or otherwise modified to provide enhanced comfort for a user of the head-mounted device.

To help protect the privacy of users, any personal user information that is gathered by device 10 may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A headband system configured to be coupled to a head-mounted device comprising a head-mounted housing and to be worn on a head, the headband system comprising:
an overhead strap comprising a first end and a second end, wherein the first end is coupled to the head-mounted housing at a front of the head; and
a counterweight coupled to the second end of the overhead strap at a rear of the head.

2. The headband system of claim 1, wherein the head-mounted housing comprises a main portion, a face track, and a light seal, and the first end of the overhead strap is coupled to the main portion.

3. The headband system of claim 1, wherein the head-mounted housing comprises a main portion, a face track, and a light seal, and the first end of the overhead strap is coupled to the face track or the light seal.

4. The headband system of claim 1, wherein the head-mounted housing comprises an extension with a connection point, the head-mounted device further comprising:
a rear headband coupled to the connection point.

5. The headband system of claim 4, wherein the counterweight is coupled to the rear headband.

6. The headband system of claim 4, wherein the rear headband has a first portion coupled to the connection point and a second portion coupled to the second end of the overhead strap.

7. The headband system of claim 1, wherein the head-mounted housing comprises a front portion, and the counterweight is configured to couple to the front portion to stow the counterweight.

8. A headband system configured to be coupled to a head-mounted device comprising a head-mounted housing with an extension, the headband system comprising:
an upper headband configured to be coupled to the extension and to extend from the extension at a first angle;
a rear headband configured to be coupled to the extension and to extend from the extension at a second angle that is different from the first angle; and
a pad coupled to the upper headband.

9. The headband system of claim 8, further comprising:
a counterweight coupled to a support, wherein the support is configured to be coupled to the extension.

10. The headband system of claim 9, wherein the pad comprises a foam pad that is rotatably coupled to the upper headband.

11. The headband system of claim 8, wherein the pad comprises a foam pad that is embedded in the upper headband.

12. The headband system of claim 11, further comprising:
a counterweight coupled to the rear headband.

13. The headband system of claim 12, wherein the counterweight comprises a plurality of weighted particles embedded in the rear headband.

14. The headband system of claim 8, wherein the upper headband and the rear headband are configured to be coupled to the extension with a torsion spring, and wherein the torsion spring is configured to provide a rotational force to counteract a weight of the head-mounted device.

15. The headband system of claim 8, further comprising:
an additional headband that extends from the upper headband, wherein the additional headband is configured to contact a forehead of a user when worn.

16. The headband system of claim 8, further comprising:
an additional headband that extends from the upper headband and that is configured to be coupled to the head-mounted housing.

17. The headband system of claim 8, wherein the upper headband has a first portion configured to be coupled to the extension and a second portion that is configured to be coupled to an additional portion of the head-mounted housing.

18. The headband system of claim 8, wherein the first angle is at least 25° from a line perpendicular to the extension, and the second angle is at least 15° from the line perpendicular to the extension.

19. The headband system of claim 8, further comprising:
a counterweight coupled to a hanger, wherein the hanger is configured to attach to the extension, and the counterweight is configured to rest on a front portion of a user when worn.

20. The headband system of claim 8, further comprising:
a tensioner comprising a first end and a second end, wherein the first end of the tensioner is configured to attach to the rear headband and the second end of the tensioner is configured to attach to a portion of a user.

21. The headband system of claim 8, wherein the rear headband comprises a plurality of links coupled to one another with ball and socket joints.

22. The headband system of claim 8, wherein the upper headband comprises a comb.

23. A headband system configured to be coupled to a head-mounted device comprising a head-mounted housing and an extension from the head-mounted housing, the headband system comprising:
an overhead strap comprising a first end and a second end, wherein the first end is coupled to the head-mounted housing;
a counterweight coupled to the second end of the overhead strap; and
a headband coupled to the extension.

24. The headband system of claim 23, wherein the headband comprises a first portion that is coupled to the extension and an opposing second portion that is coupled to the second end of the overhead strap.

25. The headband system of claim 23, wherein the counterweight comprises a battery configured to be coupled to the head-mounted device.
